(19) United States
(12) Patent Application Publication
(10) Pub. No.: US 2006/0232986 A1
(43) Pub. Date: Oct. 19, 2006

(54) Display device for vehicle

(75) Inventors: Tomoyuki Miyagaki, Handa-city (JP); Yutaka Imai, Toyota-city (JP)

Correspondence Address: NIXON & VANDERHYE, PC, 901 NORTH GLEBE ROAD, 11TH FLOOR, ARLINGTON, VA, 22203, US

(73) Assignees: Denso Corporation, Kariya-city (JP); Toyota Jidosha Kabushiki Kaisha, Toyota-city (JP)

(21) Appl. No.: 11/404,009

(22) Filed: Apr. 14, 2006

(30) Foreign Application Priority Data
Apr. 14, 2005 (JP) 2005-117118

(51) Int. Cl. B60Q 1/00

(52) U.S. Cl. 362/459

(57) ABSTRACT

A display device for a vehicle has a first display section for displaying measuring information, a second display section for displaying messages, a switching means for connecting the first display section and the second display section to a power source, and a control means for controlling displaying operations of the first display section and the second display section. When the switching means is turned on, the control means supplies an electric power to the second display section prior to the first display section.

### CROSS REFERENCE TO RELATED APPLICATION

This application is based on Japanese Patent Application No. 2005-117118 filed on Apr. 14, 2005, the disclosure of which is incorporated herein by reference.

### FIELD OF THE INVENTION

The present invention relates to a display device for a vehicle.

### BACKGROUND OF THE INVENTION

In a display device mounted on a vehicle, it is known to display a meter part and a message display part in one display area. In the meter part, for example, various measurement information such as a vehicle speed and a rotational speed of an engine is indicated by an analog meter having a pointer and a dial board with scales. The message display part is for example composed of a liquid crystal display device. Letters and characters for indicating messages and warning information are displayed on the liquid crystal display device. This kind of vehicle-mounted display device is for example disclosed in Japanese Unexamined Patent Publication No. 2001-281012.

Such a vehicle-mounted display device is operated when an ignition switch is turned on. On starting the operation of the display device, the message display part is illuminated at the same time as illuminating the dial board and the pointer of the meter part. Namely, the whole of the display device is illuminated at the same time. Therefore, even if warning information is indicated or a message is indicated with a quality appearance on the message part, it is less likely that a user will easily notice the warning information or the message.

### SUMMARY OF THE INVENTION

It is an object of the present invention to provide a display device for a vehicle, which displays messages with an enhanced visibility.

According to an aspect of the present invention, a display device for a vehicle has a first display section for displaying measurement information, a second display section located adjacent to the first display section for displaying a message, a switching means for connecting the first display section and the second display section to a power source, and a control means for controlling display operations of the first display section and the second display section. When the switching means is turned on, the control means supplies an electric power to the second display section prior to the first display section.

Accordingly, the second display section is displayed before the first display section is displayed. Therefore, the messages such as warning information and the like effectively appear on the second display section. As a result, the user is likely to easily notice the messages.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic front view of a display device for showing a display area according to an example embodiment of the present invention;

FIG. 2 is a schematic block diagram of a control system of the display device according to the example embodiment; and

FIG. 3 is a time chart for showing an operation of the display device according to the example embodiment.

### DETAILED DESCRIPTION OF EXAMPLE EMBODIMENTS

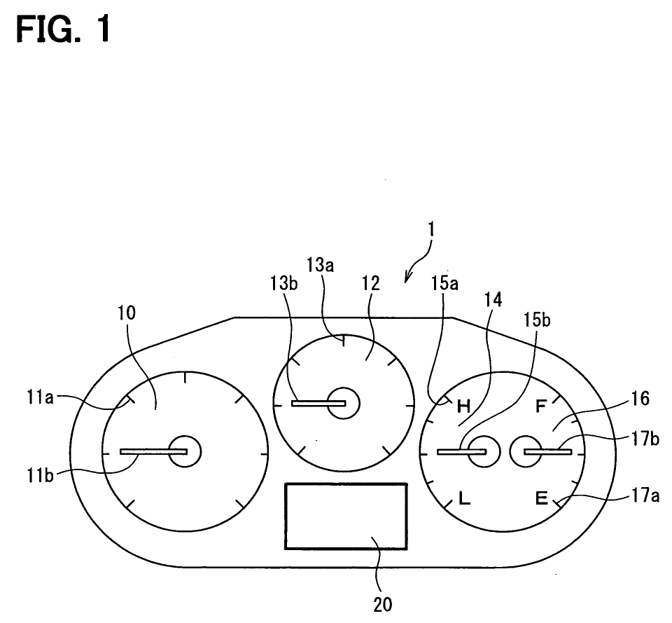

An example embodiment of the present invention will now be described with reference to FIGS. 1 to 3. A vehicle-mounted display device 1 of the example embodiment includes a first display section for displaying measuring information and a second display section for displaying messages in a display area.

As shown in FIG. 1, the first display section for example includes a speed meter 10 for indicating a vehicle speed, a tachometer 12 for indicating a rotational speed of an engine, a coolant temperature gauge 14 for indicating a temperature of an engine coolant, a fuel gauge 16 for indicating a remaining quantity of a fuel. The second display section is for example composed of a liquid crystal display part (hereafter, referred to as LCD) 20.

Each of the speed meter 10, the tachometer 12, the coolant temperature gauge 14 and the fuel gauge 16 is formed as an analog meter, and has a dial board formed with scales and/or letters 11a, 13a, 15a, 17a and a pointer 11b, 13b, 15b, 17b. The pointers 11b, 13b, 15b, 17b are rotatably supported to indicate respective measured values on the dial boards.

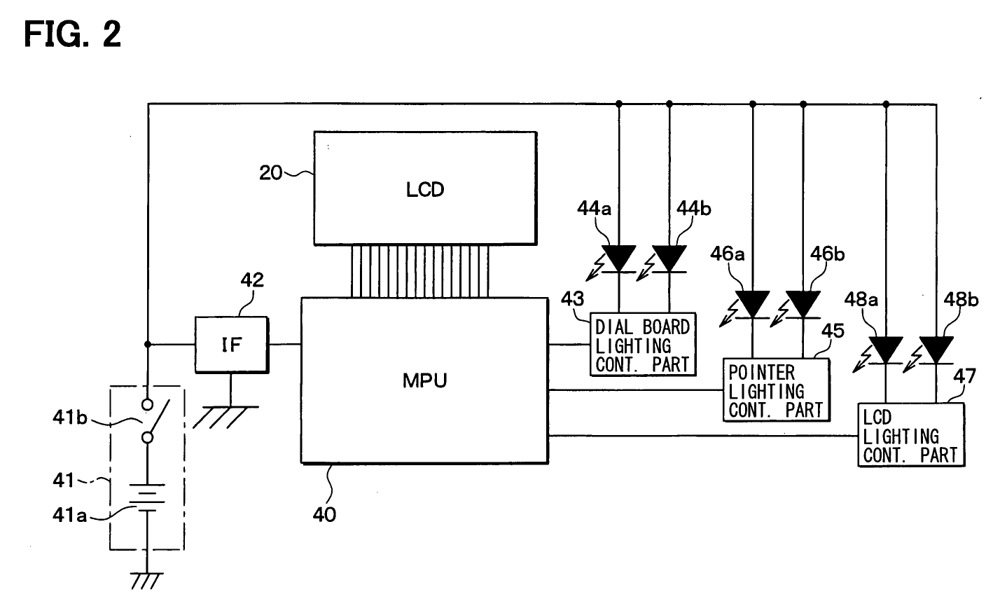

On the rear side of the dial boards of the meters and gauges 10, 12, 14, 16, plural light sources (e.g., 44a, 44b in FIG. 2) are provided for illuminating the respective dial boards. The light source is for example composed of a light emitting diode (LED). Likewise, each of the pointers 11b, 13b, 15b, 17b is provided with a light source such as an LED (e.g., 46a, 46b in FIG. 2) and is illuminated by the light source.

The LCD 20 of the second display section is for example composed of a dot matrix display device. The LCD 20 displays letters, figures and/or characters thereon for indicating messages relating to operations, warning information and the like. The LCD 20 is matrix-driven for displaying the letters and the like. Further, the LCD 20 is illuminated by a light source (e.g., LED, 48a, 48b in FIG. 2) provided on a back side thereof so that a user can easily see the letters and the like on the LCD 20.

As shown in FIG. 2, the first display section and the second display section are operated by a microprocessor unit (MPU) 40 as a control unit. An electric power is supplied from a power source unit (IG) 41 to the MPU 40 through an interface (IF) 42. The power source unit 41 includes a power source 41a and an ignition switch 41b.

The MPU 40 matrix-drives the LCD 20 so that the letters and figures indicating the messages are displayed on the LCD 20. The MPU 40 is connected to a dial board lighting control part 43, a pointer lighting control part 45 and a LCD lighting control part 47.

The dial board lighting control part 43 is connected to the dial board light sources 44a, 44b in series. The dial board light sources 44a, 44b receive power voltage from the power source unit 41. The dial board lighting control part 43 makes the dial board light sources 44a, 44b to emit light, according to an operation instruction from the MPU 40. Also, the dial board lighting control part 43 controls the brightness of the light emitted from the dial board light sources 44a, 44b. Although the plurality of light sources is provided for lighting the scales and letters of the dial boards of the meters and gauges 10, 12, 14, 16 of the first display section, only two light sources 44a, 44b are exemplarily illustrated in FIG. 2.

The pointer lighting control part 45 is connected to the pointer light sources 46a, 46b in series. The pointer light sources 46a, 46b receive power voltage from the power source unit 41. The pointer lighting control part 45 makes the pointer light sources 46a, 46b to emit light according to the operation instruction from the MPU 40. Also, the pointer lighting control part 45 controls the brightness of the light emitted from the pointer light sources 46a, 46b. Although the plurality of pointer light sources are provided for lighting the pointers 11b, 13b, 15b, 17b of the first display section, only two light sources 46a, 46b are exemplarily illustrated in FIG. 2.

The LCD lighting control part 47 is connected to one of or a plurality of LCD light sources 48a, 48b in series. The LCD light sources 48a, 48b receive power voltage from the power source unit 41. The LCD lighting control part 47 makes the LCD light sources 48a, 48b to emit light according to the operation instruction from the MPU 40.

The brightness of the light emitted from the light sources 44a, 44b, 46a, 46b, 48a, 48b can be arbitrarily controlled according to an intensity of an external light or a user's setting. In this case, the light sources 44a, 44b, 46a, 4b are controlled by the lighting control parts 43, 45, 47 through a light modulation circuit (not shown).

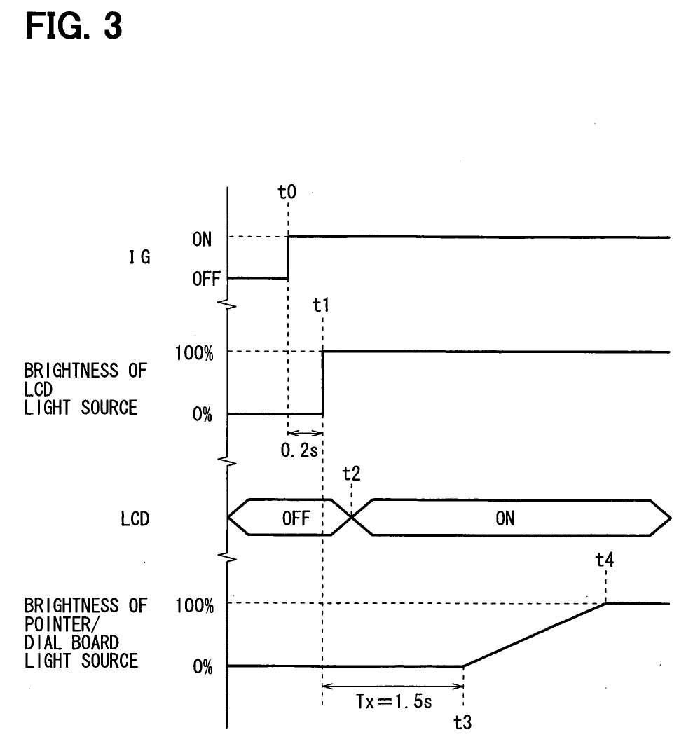

Next, an operation of the display device 1 will be described with reference to FIG. 3. When the ignition switch 41b is turned on at a timing t0, the LCD lighting control part 47 immediately starts operation and the LCD light sources 48a, 48b emit light to illuminate the LCD 20. In this example embodiment, the brightness of the LCD light sources 48a, 48b reaches a predetermined level (e.g., 100%) at a timing t1, which is shortly after the LCD light sources 48a, 48b started to emit light. For example, the brightness of the LCD light sources 48a, 48b reaches 100%, 0.2 seconds after the timing to.

Then, at a timing t2, the LCD 20 displays the letters and the like for indicating the messages that are related to a condition when the ignition switch 41b is turned on. Here, it is not always necessary to delay the timing t1 of lighting the LCD light sources 48a, 48b from the timing t0, and the timing t2 of displaying the LCD 20 from the timing t1. Namely, the LCD light sources 48a, 48b can be lit and the messages of the LCD 20 can be displayed without having the above time lags.

At the timing t2, the LCD 20 is lit by the LCD light sources 48a, 48b from the back side, and the letters and figures for showing the messages at the time of starting the operation are displayed on the LCD 20. At this point, the pointers 11b, 13b, 15b, 17b and the dial boards of the first display section are not illuminated yet. Accordingly, the user is likely to easily notice the messages on the second display section 20.

When a predetermined time period Tx has elapsed after the brightness of the LCD light sources 48a, 48b reached the predetermined level (e.g., 100%), that is, at a timing t3, the dial board lighting control part 43 and the pointer lighting control part 45 start operation based on the operation instructions of the MPU 40. Accordingly, the dial board light sources 44a, 44b and the pointer light sources 46a, 46b start to emit light at the timing T3.

Here, the predetermined time period Tx is for example 1.5 seconds. The predetermined time period Tx is provided to direct an attention of the user to the messages on the LCD 20 and to improve its visibility.

The dial board lighting control part 43 and the pointer lighting control part 45 make the light sources 44a, 44b, 46a, 46b to emit light at the timing t3. Further, the dial board lighting control part 43 and the pointer lighting control part 45 control the light sources 44a, 44b, 46a, 46b so that the brightness of the light sources 44a, 44b, 46a, 46b gradually increases until a timing t4. Here, a time period between the timing t3 and the timing t4 is for example one or two seconds.

Accordingly, when the ignition switch 41b is turned on, the power source is supplied to the second display section prior to the first display section. Namely, when the ignition switch 41b is turned on, the LCD 20 of the second display section is operated to display the messages and the LCD light sources 48a, 48b are lit. At this time, the remaining display section is not illuminated. Therefore, since only the second display section 20 is illuminated first, the user can easily notice the messages on the second display section 20. Also, this condition continues for the predetermined time period Tx. Therefore, the visibility of the second display section 20 improves.

When the predetermined time period Tx has elapsed after illuminating the second display section 20, the first display section is displayed by illuminating the dial boards and the pointers 11b, 13b, 15b, 17b. Further, the brightness of the dial boards and the pointers 11b, 13b, 15b, 17b gradually increases. Accordingly, the user is likely to move his/her eyes from the second display section to the first display section that has started to illuminating. Further, since the brightness of the first display section gradually increases, a quality appearance of the first display section improves.

In the example embodiment shown in FIGS. 1 to 3, the second display section is composed of the liquid crystal display that does not self-illuminate. To improve the visibility of the second display section, the second display section 20 is illuminated by the LCD light source 48a, 48b from the rear side. However, the structure of the second display section 20 is not limited to the above.

For example, the second display section 20 can be composed of a self-illuminating display device such as a vacuum fluorescent display (VFD) and an electroluminescence (EL) display. In this case, the LCD light sources 48a, 48b and the LCD lighting control part 47 are not required. The VFD or the EL display can illuminate as it is controlled by the MPU 40.

In the above example embodiment, the display device 1 starts operation when the ignition switch 41b is turned on. The display device 1 can start the operation at another timing. For example, the display device 1 starts the operation when a door of the vehicle is opened and closed. In this case, a door switch is provided as a switching means. For example, when the door is opened, the switching means is closed. Accordingly, the electric power is supplied to the second display section prior to the first display section, in a manner similar to the above example embodiment. Alternatively, a lighting switch can be provided as the switching means. When the lighting switch is turned on, the electric power is supplied to the second display section 20 prior to the first display section 10, 12, 14, 16.

In the above example embodiment, the speed meter 10, the tachometer 12, the coolant temperature gauge 14 and the fuel gauge 16 are displayed as the first display section. However, the information displayed as the first display section is not limited to the above example embodiment. Also, the meters 10, 12 and he gauges 14, 16 can be arranged in different ways as that of the illustration of FIG. 1. Further, in the first display section, the pointers 11b, 13b, 15b, 17b and the dial boards can be illuminated in due order as long as there parts are illuminated after the second display section. Furthermore, the light sources are not limited to the LED.

Preferred embodiments of the present invention are described above. However, the present invention is not limited to the above embodiments, but may be implemented in other ways without departing from the spirit of the invention.

What is claimed is:

1. A display device for a vehicle, comprising:
a first display section for displaying measurement information;
a second display section located adjacent to the first display section for displaying a message;
a switching means for connecting the first display section and the second display section to a power source; and
a control means for controlling the first display section and the second display section, wherein the control means supplies an electric power to the second display section prior to the first display section when the switching means is turned on.

2. The display device according to claim 1, wherein the control means starts to display the second display section when the switching means is turned on, and starts to display the first display section when a predetermined time period has elapsed after starting displaying the second display section.

3. The display device according to claim 1, wherein
the second display section is composed of a liquid crystal display device and a light source, and
when the switching means is turned on, the control means controls the liquid crystal display device to display the message thereon and the light source to emit light to the liquid crystal display device.

4. The display device according to claim 1, wherein the second display section is composed of a self-illuminating display device.

5. The display device according to claim 1, wherein
the first display section includes an analog meter having a pointer and a dial board with scales, and
the control means displays the first display section by illuminating the pointer and the dial board.

6. The display device according to claim 5, wherein the pointer and the dial board are illuminated when a predetermined time period has elapsed after the second display section is displayed, and brightness of the dial board and the pointer is gradually increased.
